(19) United States
(12) Patent Application Publication
(10) Pub. No.: US 2026/0359109 A1
(43) Pub. Date: Nov. 12, 2026

(54) MANAGEMENT PACKET SYNCHRONIZATION AND LATENCY REDUCTION FOR USER-MODE TASK QUEUES

(71) Applicant: QUALCOMM Incorporated, San Diego, CA (US)

(72) Inventors: Karthik Kannan, San Diego, CA (US); Yifeng Zhang, San Diego, CA (US); Kade Jeffery Boltjes, San Diego, CA (US); Michael Castelloe, San Diego, CA (US)

(21) Appl. No.: 19/661,320

(22) Filed: Apr. 28, 2026

Related U.S. Application Data
(60) Provisional application No. 63/801,470, filed on May 7, 2025.

(51) Int. Cl. G06F 9/48

(52) U.S. Cl. CPC G06F 9/4881

(57) ABSTRACT

This disclosure provides systems, methods, and devices for inference packet processing are provided. In one aspect, a method is provided in which a first processor adds a first inference packet to a queue and adds a first inference packet to a management thread associated with the first inference packet to a first management thread. The first processor may also add a second management packet associated with a second inference packet to a second management thread. The queue, the first management thread, and the second management thread may be associated with a second processor that executes the first inference packet responsive to the adding of the first management packet and transmits the first management packet to the first processor upon completion of execution of the first transmission packet. Other aspects are provided.

### CROSS-REFERENCE TO RELATED APPLICATIONS

This application claims the benefit of U.S. Provisional Application No. 63/801,470, entitled, “MANAGEMENT PACKET SYNCHRONIZATION AND LATENCY REDUCTION FOR USER-MODE TASK QUEUES,” filed on May 7, 2025 which is expressly incorporated by reference herein in its entirety.

### TECHNICAL FIELD

Aspects of the present disclosure relate generally to integrated circuits, and more particularly, to integrated circuits for improving processing systems such as may be used in system on chips (SoCs). Some features may enable and provide improved inference packet processing and execution.

### INTRODUCTION

Modern computing systems, particularly System-on-Chip (SoC) designs, often employ heterogeneous architectures. These architectures may integrate one or more general-purpose processors, such as Central Processing Units (CPUs), with specialized hardware accelerators, such as Neural Processing Units (NPUs) or Digital Signal Processors (DSPs). Such specialized processors may be optimized to efficiently execute specific types of computationally intensive tasks, for example, those associated with Artificial Intelligence (AI), Machine Learning (ML), or signal processing workloads.

Applications running on the general-purpose processor may typically operate in a user mode, which may have limited direct access to hardware resources. To utilize specialized accelerators like an NPU, these applications often interact with the operating system (OS) kernel, which runs in a privileged kernel mode. Communication and task scheduling between the main processor and the specialized accelerator may be managed through various software layers, including device drivers and OS scheduling components, to coordinate the execution of tasks on the appropriate processing unit. Mechanisms such as shared memory and inter-processor communication (IPC) protocols may be employed to facilitate data transfer and control signaling between the different processors within the heterogeneous system.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present techniques relate to systems and methods for submitting workloads, such as Artificial Intelligence (AI) inference tasks, from a first processor (e.g., a CPU) to a second, specialized processor (e.g., an NPU or DSP) in a heterogeneous computing system. These techniques may utilize a hybrid approach combining a low-latency user-mode queue for transferring inference packets containing task data and a kernel-mode path for submitting corresponding management packets via dedicated management threads. The arrival of a management packet at the second processor may enable the execution of the corresponding inference packet, such as within the execution context of the management packet itself, thereby allowing operating system (OS) scheduler oversight. Latency associated with the kernel-mode submission of management packets may be hidden by proactively submitting a subsequent (N+1)th management packet while the Nth inference packet is executing on the second processor. Optional batching mechanisms may allow a single management packet to process multiple short-duration inference packets from the user-mode queue, and may improve throughput while maintaining OS-level accounting via the management packet.

In one aspect, a method includes adding, by a first processor, a first inference packet to a queue associated with a second processor; adding, by the first processor, a first management packet to a first management thread associated with the second processor, the first management packet corresponding to the first inference packet; executing, by the second processor, the first inference packet responsive to the adding of the first management packet to the first management thread; adding, by the first processor, a second management packet to a second management thread associated with the second processor before completion of execution of the first inference packet; and transmitting the first management packet from the first management thread to the first processor responsive to completion of execution of the first inference packet.

In another aspect, a system includes a first processor and a second processor, wherein the first processor is configured to add a first inference packet to a queue associated with the second processor and add a first management packet to a first management thread associated with the second processor, the first management packet corresponding to the first inference packet; wherein the second processor is configured to execute the first inference packet responsive to the adding of the first management packet to the first management thread; wherein the first processor is further configured to add a second management packet to a second management thread associated with the second processor before completion of execution of the first inference packet; and wherein the second processor is further configured to transmit the first management packet from the first management thread to the first processor responsive to completion of execution of the first inference packet.

In a further aspect, a System-on-a-Chip (SoC) includes a first processor and a second processor, wherein the first processor is configured to add a first inference packet to a queue associated with the second processor and add a first management packet to a first management thread associated with the second processor, the first management packet corresponding to the first inference packet; wherein the second processor is configured to execute the first inference packet responsive to the adding of the first management packet to the first management thread; wherein the first processor is further configured to add a second management packet to a second management thread associated with the second processor before completion of execution of the first inference packet; and wherein the second processor is further configured to transmit the first management packet from the first management thread to the first processor responsive to completion of execution of the first inference packet.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices. By way of example, they may be incorporated into stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a system-on-chip (SoC) configured for performing signal processing according to one or more aspects of this disclosure.

FIG. 2 is a block diagram illustrating an example implementation of aspects of this disclosure in a processing system for a mobile device according to one or more aspects of the disclosure.

FIGS. 3A and 3B show systems for inference packet processing according to aspects of this disclosure.

FIG. 4 shows a flow chart of an example method for inference packet processing according to one or more aspects of this disclosure.

Like reference numbers and designations in the various drawings indicate like elements.

### DETAILED DESCRIPTION

The present disclosure provides systems, apparatus, methods, and computer-readable media that support improved integrated circuit operation, including techniques for inference packet processing.

In heterogeneous computing systems, applications may typically operate in various modes, including a “user mode” and a “kernel mode”. Applications may primarily operate in user mode, which may represent an environment where applications run with limited privileges. This isolation helps ensure that individual applications cannot directly access critical system resources or inadvertently cause system-wide instability. When a user-mode application needs to perform operations that require higher privileges, such as interacting with hardware or managing system resources, it may issue a request, or system call, to a kernel of the operating system, which operates in a privileged "kernel mode." Kernel mode processing allows the central components of the operating system to execute with full access to hardware resources, enabling them to perform essential tasks like memory management, device control, and interrupt handling, thereby facilitating the efficient and secure execution of critical system functions. After handling the request, the system typically switches context back to user mode for the application to continue. Thus, a key distinction lies in their access capabilities: kernel mode has unrestricted access, whereas user mode applications have limited access and must rely on system calls to the kernel to perform privileged operations, as they cannot directly access hardware or memory without such mediation.

In such environments, efficiently submitting workloads from a user-mode application on a first processor (e.g., CPU) to a specialized second processor (e.g., NPU) presents challenges. One common approach involves submitting tasks via the operating system's kernel mode scheduler. An application transitions from user mode to kernel mode to request task execution. The kernel scheduler then manages the task, and may consider factors like Quality of Service (QoS), priority, and system load, before dispatching it to the second processor, often involving hardware interrupts for communication. While this provides the operating system (OS) with full visibility and control for scheduling, prioritization, preemption, and resource accounting, the associated mode transitions and interrupt handling may introduce significant communication overhead, often referred to as structural latency. For example, the structural latency associated with kernel mode submission may be on the order of ten to fifteen times greater than that of user-mode shared memory queue approaches. This latency can become a bottleneck, particularly for tasks requiring synchronous execution or frequent, small workloads, which may result in underutilizing the specialized processor's capabilities.

An alternative approach utilizes a user-mode shared memory queue. An application, which may use a library, writes task information (e.g., an inference packet) directly into a shared memory region accessible by both processors. Logic on the second processor, often involving polling, detects and retrieves the task from the queue for execution. Results may be returned via the same queue. This method may significantly reduce the Inter-Processor Communication (IPC) latency by bypassing the kernel submission path and associated overheads, achieving queue latencies of a few microseconds (e.g., approximately 5 to 15 microseconds). However, this direct user-mode communication completely circumvents the OS kernel scheduler. Consequently, the OS may lose visibility into the workload being executed on the second processor, leading to inaccurate utilization reporting, an inability to enforce system-wide priorities or QoS policies effectively, difficulty in preempting tasks on the accelerator, and potential challenges in managing overall system resources and power, which may negatively impact system stability or user experience. Continuous polling by the second processor can also consume unnecessary power.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Solutions to the problems identified above may include employing a hybrid approach that combines aspects of both user-mode queue submission and kernel-mode scheduling. The described techniques may utilize a user-mode queue, which may be implemented as shared memory, for the efficient transfer of inference packets from an application on a first processor to a second processor. Concurrently, dedicated management threads, which may be created and managed by a library framework on the first processor and hidden from the application, may be used. These management threads may submit corresponding management packets for each inference packet via the standard OS kernel scheduler path. The execution of an inference packet on the second processor may be contingent upon the arrival of its corresponding management packet via this kernel path. Furthermore, the inference logic may execute directly within the execution context provided by the arrived management packet, rather than a separate NPU-side callback thread. This may ensure that all execution time on the second processor is associated with a kernel-managed entity (the management packet), allowing the OS scheduler to maintain visibility and control for accounting, prioritization, preemption, and QoS enforcement, thus addressing the shortcomings of purely user-mode submission.

To mitigate the structural latency associated with the kernel path submission of management packets, the present techniques may proactively submit the management packet for the next (N+1)th inference task while the current (Nth) inference task is still executing on the second processor. This proactive submission may be triggered based on conditions such as the completion of the (N-1)th task's management packet processing and the addition of the Nth inference packet to the user-mode queue. If the execution duration of the Nth inference packet is greater than the IPC latency of the (N+1)th management packet's journey through the kernel, that latency may be effectively hidden or overlapped with useful computation. This may allow the (N+1)th inference task to start with minimal delay after the Nth task completes, achieving performance characteristics that may approach those of user-mode polling systems for sufficiently long tasks, while resolving the latency issue of traditional kernel submission. For workloads dominated by very short inference durations, an optional batching mechanism may allow a single management packet context to process multiple inference packets sequentially from the user-mode queue (up to a configurable limit) if the next management packet has not yet arrived, maintaining high throughput in such scenarios.

Particular implementations of the subject matter described in this disclosure may be implemented to realize one or more of the following potential advantages or benefits. In some aspects, the present disclosure provides techniques for hybrid user-kernel mode workload submission that may be particularly beneficial in heterogeneous computing systems employing specialized accelerators like NPUs or DSPs. For example, these techniques may achieve low IPC latency, which may approach the performance of user-mode shared memory queue polling methods, especially for inference tasks whose execution duration exceeds the kernel-path latency of the associated management packets. This may be accomplished by proactively submitting management packets and overlapping their kernel submission latency with the execution time of preceding inference tasks. Unlike purely user-mode methods, however, the described techniques may maintain full integration with the operating system's kernel scheduler. Because inference execution may occur within the context of kernel-submitted management packets, the OS may still retain visibility and control, enabling effective scheduling, prioritization, preemption, QoS enforcement, and accurate system resource accounting, which are benefits typically associated only with slower, traditional kernel-mode submission paths.

Furthermore, the described techniques may simplify the execution model on the second processor by eliminating the need for a separate callback thread often used in prior user-mode queue implementations; inference logic may run directly within the management packet's context. For tasks with very short execution times, performance may still be improved compared to traditional kernel submission. Without batching, the return path latency of the management packet may be hidden from the application's perspective. With optional batching enabled, throughput for short inferences may be further increased, such as by matching user-mode polling performance, albeit with OS visibility reduced to the granularity of the batched management packet rather than individual inferences. These improvements may lead to more efficient utilization of specialized hardware accelerators and a better end-user experience due to faster and more responsive execution of applications relying on these accelerators (e.g., AI-powered features). The techniques may improve the overall functioning of the computer system by enabling both high-performance accelerator access and robust OS-level management and monitoring, without requiring hardware modifications.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

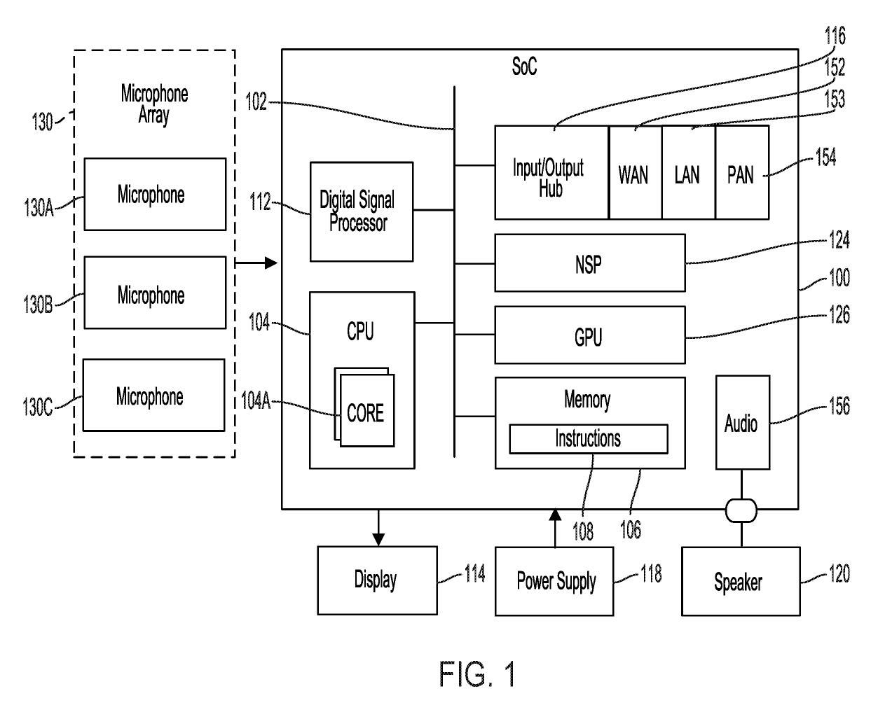

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the SoC 100 is a DSP 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a CPU 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112.

The SoC 100 may further include a NSP 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 100 may be coupled to a display 114 for interacting with a user. The SoC 100 may also include a GPU 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

The SoC 100 may include an integrated circuit, such as included in one of the DSP 112, CPU 104, NSP 124, GPU 126, to process and execute inference packets.

Processing algorithms, techniques, and methods may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the DSP 112 or the CPU 104 executes instructions to perform various operations described herein, including one or more inference operations, such as for AI or DSP applications. For example, execution of the instructions by the CPU 104 as part of an audio application (e.g., a voice recorder, a sound recording, or a video recorder) may instruct the DSP 112 to begin or end capturing audio from one or more microphones 130A-C. The operations of the CPU 104 may be based on user input. For example, a voice recorder application executing on CPU 104 may receive a user command to begin a voice recording upon which audio comprising one or more channels is captured and processed for playback and/or storage. Audio processing to determine “output” or “corrected” signals, such as according to techniques described herein, may be applied to one or more segments of audio in the recording sequence.

Input/output components may be coupled to the SoC 100 through a hub 116 for input/output (I/O) devices. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the WAN adaptor 152, LAN adaptor 153, and PAN adaptor 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 156 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 156 and/or other processors of the SoC (e.g., CPU 104, DSP 112, GPU 126, NSP 124).

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a power supply 118 with limited capacity such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a battery. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer Three files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. For example, a mobile gaming device may include the SoC 100 with a display and multiple user controls integrated in a single unit. As another example, a mobile phone may include the SoC 100 with a display and modem for communicating on one or more wireless networks through one or more antennas. As such, the present disclosure is not limited to a specific device or configuration of components.

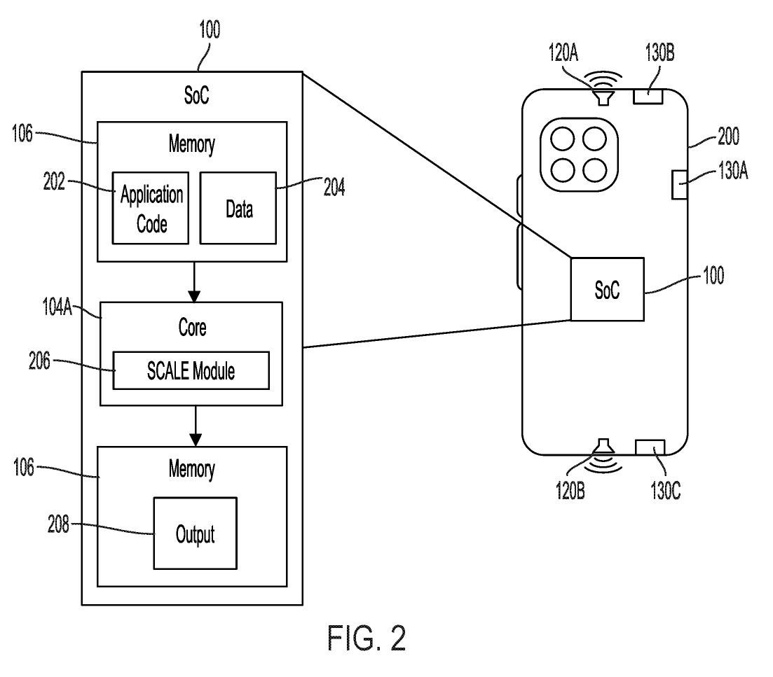

One example integration of aspects of this disclosure into a mobile device are shown in FIG. 2 and described below. FIG. 2 is a block diagram illustrating an example implementation of aspects of this disclosure in a processing system for a mobile device according to one or more aspects of the disclosure. SoC 100 may include 104A and memory 106, similar to that shown in FIG. 1. The memory 106 may store the application code 202 and data 204. The application code may include instructions that, when executed by core 104A or other processing circuitry (such as NSP 124, GPU 126, and/or DSP 112), causes the SoC, and thus the mobile device 200 to perform operations described by the instructions (examples of which are described herein). The core 104A may retrieve instructions, such as application code 202, from memory 106 and execute those instructions to operate on data 204. Execution of instructions by the core 104A may include execution of logic in scale module 206. After executing instructions, some of which may operate on data 204, the core 104A may generate output 208, which may be stored in memory 106.

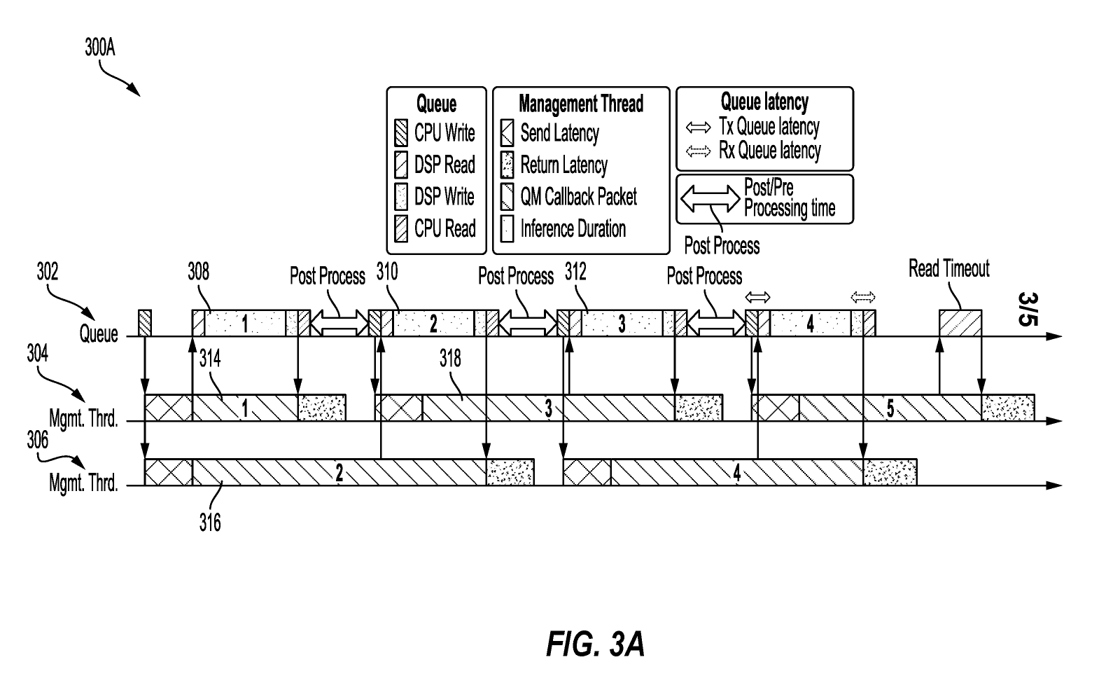

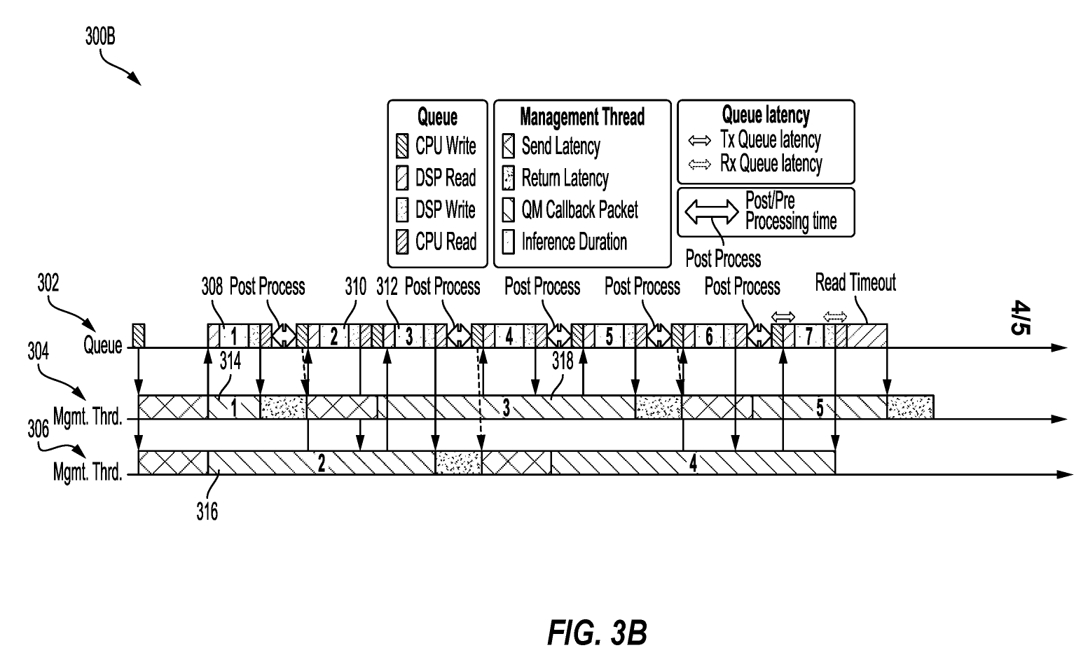

The device of FIGS. 1 or 2 may be configured to perform operations described with reference to FIGS. 3A and/or 3B to process and execute inference packets. FIGS. 3A and 3B illustrate exemplary timing diagrams for processing inference packets according to certain aspects of the present disclosure. FIG. 3A depicts a system 300A performing a non-batched processing flow, while FIG. 3B depicts a system 300B performing a batched processing flow. Certain operations discussed below may be similar between the processing flows shown in FIGS. 3A and 3B, while other operations may differ between the processing flows shown in FIG. 3A and 3B, as explained further below. Furthermore, the systems 300A, 300B may be the same system processing different inference packets.

The first processor may be configured to add a first inference packet 308 to a queue 302 associated with a second processor. This operation may occur within a heterogeneous computing environment, such as a System-on-Chip (SoC) architecture. In such implementations, the first processor may be a general-purpose Central Processing Unit (CPU) responsible for running the main operating system (OS), user-mode applications, associated software libraries, or a combination thereof. The second processor may be a specialized hardware accelerator, such as a Neural Processing Unit (NPU) or Digital Signal Processor (DSP), optimized for specific, computationally intensive tasks such as executing Artificial Intelligence (AI) or Machine Learning (ML) inference workloads.

In certain implementations, an inference packet 308 may refer to a data structure containing the necessary information for the second processor to perform an inference task. For example, the first inference packet 308 may include input data (such as image pixels, audio samples, or text embeddings), an identifier for the specific AI model to be used, instructions or parameters for the execution, metadata related to the task, or a combination thereof.

In certain implementations, the queue 302 may represent a communication mechanism accessible from the user mode of the first processor, enabling the transfer of the first inference packet 308 to the second processor without requiring direct kernel intervention for the data transfer itself. An application running in user mode on the first processor may initiate the addition of the first inference packet 308 to the queue 302, such as by invoking an Application Programming Interface (API) function provided by a dedicated communication library, which may be referred to as a queue library.

In certain implementations, the queue 302 may include a user-mode shared memory region accessible by both the first processor and the second processor. This shared memory region may be allocated and managed by the queue library upon request from the application (such as during queue initialization). Access control mechanisms, such as memory permissions managed by the OS or Memory Management Unit (MMU), may ensure that only authorized processes (the application on the first processor and the relevant driver or process on the second processor) can read from and write to this shared memory. Such a shared memory approach may differ from kernel-managed communication buffers, which may typically require system calls and context switches for access, which may introduce higher latency.

The addition of the first inference packet 308 to the queue 302 may be initiated by an application thread running on the first processor (CPU). This thread, executing the logic of the AI-using application, may prepare the inference data and then may call a specific API function provided by the queue library or a similar interface, to pass the first inference packet 308 as an argument. The library function may then execute to add the first inference packet 308 into the designated shared memory queue 302 according to the queue's protocol (such as writing data, updating pointers, or a combination thereof).

The first processor may also be configured to add a first management packet 314 to a first management thread 304 associated with the second processor, where the first management packet 314 corresponds to the first inference packet 308. A management packet, which may also be referred to as a Queue Monitor (QM) callback packet, may function as a control or synchronization packet submitted through the kernel's scheduling infrastructure. Management packets may be used to enable, manage, and/or account for the execution of the corresponding user-mode-submitted inference packet (such as the first inference packet 308) on the second processor. In particular implementations, the first management packet 314 may allow an OS scheduler to retain visibility and control over the workload execution on the second processor, even though the actual inference data (in the first inference packet 308) is added via the low-latency user-mode queue 302 instead of kernel-based mechanisms. The contents of the first management packet 314 might include metadata identifying the task, pointers or handles to the inference logic or callback function to be executed on the second processor within the context of the first management packet 314. In additional or alternative implementations, the first management packet 314 may include priority information, Quality of Service (QoS) parameters recognized by the OS scheduler, information linking the first management packet 314 to the corresponding first inference packet 308 (such as a sequence number, timestamp, or memory pointer), or a combination thereof.

A management thread 304, such as the first management thread 304 or the second management thread 306, may be a software construct used to convey information between the first processor and the second processor, such as a portion of the shared memory. These management threads (such as management threads 304, 306) may be created and managed internally by the queue library framework when the queue 302 is initialized, typically hidden from the application that may use the queue 302. Each management thread's responsibility may include constructing and initiating the kernel-mode submission of its respective management packets (such as the first management packet 314, the second management packet 316, or a combination thereof). The correspondence between a management packet (such as 314) and an inference packet (such as 308) may ensure that the execution enabled by the arrival of the management packet on the second processor may process the correct inference data from the user-mode queue 302. This linkage might be maintained using sequence numbers, pointers stored within the packets or library-internal data structures, other tracking mechanisms, or a combination thereof. The trigger for the first processor (specifically, the first management thread 304) to add the first management packet 314 may occur upon detection that the corresponding first inference packet 308 has been successfully added to the queue 302 by the application thread. In some initial scenarios, the detection of the very first inference packet 308 being added to the queue 302 might trigger both the first management thread 304 to submit the first management packet 314 and the second management thread 306 to submit the second management packet 316 concurrently via the kernel scheduler.

In certain implementations, adding the first management packet 314 to the first management thread 304 may involve submitting the first management packet 314 via an operating system scheduler associated with the first processor. The first management thread 304 (or the queue library framework managing the first management thread 304) may interact with the OS kernel's packet scheduler using one or more mechanisms, such as system calls, specific kernel driver interfaces designed for submitting tasks to hardware accelerators such as the second processor, or a combination thereof. When the first management packet 314 is submitted, the OS scheduler may process the first management packet 314 similarly to other tasks submitted through the kernel path. The scheduler may apply prioritization rules, enforce QoS policies, manage resource allocation for the second processor, perform load balancing if multiple accelerators are present, preempt the execution associated with the first management packet 314 if a higher-priority task arrives, or a combination thereof. This kernel-level management may contrast sharply with the user-mode submission of the first inference packet 308 to the queue 302, which may bypass direct OS scheduler involvement for the packet transfer itself. The association of the first management thread 304 and its submitted first management packet 314 with the second processor may be established during the submission process. The system call or kernel interface used may include parameters specifying the target device (such as the NPU or DSP). The OS scheduler and underlying drivers may then route the first management packet 314 to the appropriate hardware queue or processing context on the designated second processor.

The second processor may be configured to execute the first inference packet 308 responsive to the adding of the first management packet 314 to the first management thread 304. In particular, the second processor may be configured to monitor the management threads 314, 316 for the addition or availability of a corresponding management packet upon determining that an inference packet is added to the queue 302. In certain implementations, synchronization between the availability of the inference data in the queue 302 and the enabling signal from the kernel path may be achieved through mechanisms such as the second processor's logic polling an internal queue or status register for the arrival of the first management packet 314, waiting on an interrupt or signal triggered by the kernel or driver upon the management packet's arrival, or a combination thereof. Furthermore, the second processor may be configured to identify a particular corresponding management packet. For example, if multiple management packets (such as the first management packet 314, the second management packet 316) are added to the management threads 314, 316, the second processor may be configured to use sequence numbers, task identifiers, pointers, other metadata embedded within both the first inference packet 308 (read from queue 302) and the arrived management packets (received via the kernel path), or a combination thereof, to establish a one-to-one correspondence.

In certain implementations, executing, by the second processor, the first inference packet 308 may include executing logic associated with the first inference packet 308 within an execution context provided corresponding to the first management packet 314 on the second processor. An execution context may refer to the environment, resources, state established or managed by the operating system or firmware upon the arrival and handling of the kernel-submitted first management packet 314, or a combination thereof. This context may include specific thread context information, allocated memory resources, priority levels assigned by the OS scheduler, structures used for performance monitoring and resource accounting by the kernel, or a combination thereof. The inference logic (such as logic defined or identified by the application and referenced or included, directly or indirectly, in the first inference packet 308 or first management packet 314) may be invoked and run directly within the specified execution context. By tying the execution of the inference logic directly to the kernel-managed management packet's context, the operating system scheduler may maintain accurate visibility and control over the second processor's activity, allowing for proper accounting of execution time, energy usage, enabling effective scheduling decisions (such as preemption and prioritization based on the management packet's attributes), or a combination thereof.

In certain implementations, executing the first inference packet 308 may prevent concurrent execution, by the second processor, of another inference packet (such as the second inference packet 310) within an execution context provided by a different management packet (such as the second management packet 316). To ensure orderly, sequential processing of inferences as governed by the arrival sequence of their corresponding management packets and to maintain data integrity, a mutual exclusion mechanism may be employed on the second processor. For example, the execution context associated with the first management packet 314 may be required to acquire a mutex lock or semaphore before beginning to execute the inference logic associated with the first inference packet 308. This lock may only be released after the execution is complete. If the second management packet 316 is added while the first management packet 314 context holds the lock, the second management packet 316 context may block (wait) until the lock is released, which may thus preventing the second inference packet 310 from executing concurrently with the first inference packet 308 on the same processing resource. This may ensure that the execution sequence aligns with the kernel scheduler's management via the management packets.

During the execution of an inference packet, the second processor may perform inference computation specified by the inference packet. This may include loading a specified AI model, processing the input data from the inference packet through the model's layers using one or more hardware accelerators (such as matrix multiplication units or activation function hardware in an NPU), generating the inference results (such as classification labels, object detection bounding boxes, or processed audio data), or a combination thereof. Once the computation is complete, the results may be output by writing the results back to a designated location accessible by the first processor, such as back into the user-mode shared memory queue 302.

The first processor may be configured to add a second management packet 316 to a second management thread 306 associated with the second processor before completion of execution of the first inference packet 308. For instance, the second management thread 306, operating on the first processor, may initiate the submission of the second management packet 316 through the kernel scheduler. The second management packet 316 may be created to correspond to and eventually enable the execution of a next inference packet in sequence after the first inference packet 308 (such as the second inference packet 310). The submission by the second management thread 306 may occur concurrently with at least a portion of the ongoing execution of the first inference packet 308 on the second processor. In certain implementations, the second management packet 316 may be added in parallel with the adding of the first management packet 314. This overlap may be enabled by the presence of multiple, distinct management threads managed by the queue library framework, such as the first management thread 304 and the second management thread 306. Having at least two such threads may allow one thread (such as the second management thread 306) to submit the management packet for the N+1th inference while the Nth inference, enabled by a packet submitted earlier by another thread (such as the first management thread 304), may still be executing. In particular implementations, the second management packet 316 may be added prior to the adding, by the first processor, of a corresponding second inference packet 310 to the queue 302. This may further emphasize the proactive nature of the management packet submission. By overlapping the kernel-path latency of the second management packet 316 with the execution time of the first inference packet 308 (and, in certain instances, at least a portion of application processing time on the first processor), the system may effectively hide the kernel-path latency from the overall end-to-end processing time for the second inference packet 310, provided the execution time of the first inference packet 308 is sufficiently long.

In certain implementations, the first processor may be configured to receive the first management packet 314 after execution of the first inference packet 308 has completed. Upon successfully finishing the inference task and writing results back to the queue 302, the second processor may be configured to cause the first management packet 314 to be transmitted to the first processor, such as from the first management thread to the first processor. In certain implementations, the second processor's device driver may interact with the operating system kernel, which may route the first management packet 314 to the first processor. In certain implementations, the first management packet 314 may be transmitted directly, as a corresponding notification, or a combination thereof. The notification may include additional information not contained within the first management packet 314, such as a completion status code (indicating success or detailing errors), performance metrics such as the measured execution time on the second processor, metadata, or a combination thereof.

Processing of inference packets may occur in a non-batched or a batched manner, depending on implementation choices and runtime conditions, such as the duration of inference packet execution relative to management packet latency. In non-batched processing, as illustrated in FIG. 3A, each management packet (e.g., 314, 316, 318) generally corresponds to and enables the execution of a single inference packet (e.g., 308, 310, 312, respectively). In batched processing, as illustrated in FIG. 3B, a single management packet (e.g., 316) may correspond to and enable the execution of multiple consecutive inference packets (e.g., 310, 312) under certain conditions, which may be advantageous for workloads with very short inference durations. The following sections describe these processing flows in more detail.

For example, in a non-batched processing flow illustrated in FIG. 3A, the first processor may be configured to add a second inference packet 310 to the queue 302, where the previously added second management packet 316 corresponds to the second inference packet 310. Subsequently, the second processor may be configured to execute the second inference packet 310 responsive to the adding of the second inference packet 310 to the queue 302 (and, implicitly, the arrival and availability of the corresponding second management packet 316 at the second processor). Finally, upon completion of the execution, the second processor may signal completion, which may cause information related to the second management packet 316 to be transmitted back from the second management thread 306 context (on the second processor) to the first processor. This sequence may describe the processing for the second inference packet 310, mirroring the flow for the first inference packet 308. However, a key aspect may be the effect of the proactively submitted second management packet 316. Because the second management packet 316 may have been added by the second management thread 306 and began the second management packet's journey through the kernel path while the first inference packet 308 may have been executing, the second management packet 316 may already be present or arrive very shortly after the second processor may finish with the first inference packet 308. This may allow the execution of the second inference packet 310 to commence with minimal delay attributable to the kernel submission latency, which may hide that latency and achieve performance closer to direct user-mode submission systems, while still retaining kernel oversight. The execution of the second inference packet 310 may be triggered similarly to the first inference packet 308: the second inference packet's execution may be enabled by the arrival of the corresponding second management packet 316 at the second processor, and the second inference packet 310 may run within the execution context provided by the second management packet 316.

In certain application scenarios, the second inference packet 310 may be added to the queue 302 by the first processor responsive to receiving, at the first processor, an output corresponding to the first inference packet 308. For instance, the first processor may be configured to wait until execution of a previous inference task (such as the first inference packet 308) is completed on the second processor (such as by receiving an output corresponding to the first inference packet 308) before preparing and adding the next workload (such as the second inference packet 310) to the queue 302. In particular implementations, the output corresponding to the first inference packet 308 may be received by the first processor polling the shared memory at regular intervals and determining, based on the polling, that the shared memory stores an output corresponding to the first inference packet, which may be written to the shared memory by the second processor upon completing execution of the first inference packet 308.

In additional or alternative application scenarios, the second inference packet 310 may be added to the queue 302 by the first processor prior to receiving, at the first processor, the output corresponding to the first inference packet 308. For instance, the first and second inference packets 308, 310 may be executed as part of an asynchronous workload. In such instances, the first processor may be configured to add the second inference packet 310 prior to receiving confirmation that execution of the first inference packet 308 is completed.

A similar process may be repeated for subsequent packets. The first processor may be configured to add a third management packet 318 to the first management thread 304 before the completion of the execution of the second inference packet 310. Concurrently or subsequently, the first processor may add a third inference packet 312 to the queue 302, where the third management packet 318 corresponds to the third inference packet 312. Following this, the second processor may execute the third inference packet 312 responsive to the adding of the third inference packet 312 to the queue 302 (and/or the arrival of the enabling third management packet 318). In this way, management packets may be added alternatingly between the available management threads. The proactive submission of the third management packet 318 may occur while the second inference packet 310 is executing, continuing the latency-hiding pattern established for the second management packet 316. In certain implementations, adding the third management packet 318 to the first management thread 304 may be performed responsive to adding, by the first processor, of the second inference packet 310 to the queue 302. In certain implementations, adding, by the first processor, the third management packet 318 to the first management thread 304 may be specifically responsive to receiving, at the first processor, the first management packet 314.

In general terms, a trigger mechanism for submitting subsequent management packets may be conditioned on several requirements. In certain implementations, adding the (N+1)th management packet (such as the third management packet 318) by the management packet's corresponding management thread (such as the first management thread 304) may require both the return of the (N-1)th management packet (such as the first management packet 314) to the first processor, indicating completion of the (N-1)th inference, *and* the successful addition of the Nth inference packet (such as the second inference packet 310) to the queue 302 by the first processor. This two-condition trigger may result in management packets being submitted when the previous corresponding task is known to be complete (freeing the thread) and thus that the current inference data is available in the queue 302, maintaining synchronization and enabling the pipelined latency hiding.

The amount of latency hiding achieved for a given inference packet (such as the second inference packet 310, enabled by the second management packet 316) may depend on the relative timing of the inference execution and the management packet's kernel path latency. The system (such as the first processor) may determine that a duration of the execution of the preceding inference packet (such as the first inference packet 308) on the second processor is greater than or equal to a latency associated with adding the subsequent management packet (such as the second management packet 316) and the subsequent management packet's transmission to the second processor via the kernel path. This latency may represent the time required for a management packet to travel from the first processor, through the OS kernel scheduler, and arrive at the second processor, to enable execution. When this condition is satisfied for the Nth inference packet, the kernel submission latency of the (N+1)th management packet may be fully overlapped with the execution of the Nth inference packet. Consequently, the (N+1)th management packet may be likely to be available at the second processor when the Nth inference may complete, which may allow the (N+1)th inference to start with minimal delay, mimicking the performance characteristics of low-latency user-mode polling systems while preserving OS management capabilities. For example, if the QM packet IPC latency may be estimated to be 100-150 microseconds, inferences taking longer than this duration may typically experience the full latency-hiding benefit in this non-batched mode.

As mentioned above, in certain implementations one or more inference packets may correspond to the same management packet, which may be referred to as "batching" or "batched processing". For example, and turning to FIG. 3B, the first processor may be configured to add a second inference packet 310 to the queue 302, where the second management packet 316 may correspond to the second inference packet 310. The second processor may execute the second inference packet 310 responsive to the adding of the second inference packet 310 to the queue 302. Subsequently, the first processor may add a third inference packet 312 to the queue 302. Under certain conditions detailed below, the first processor, the second processor, may be configured to determine that a single second management packet 316 should be used for both the second inference packet 310 and the third inference packet 312. The second processor may then execute the third inference packet 312 responsive to the adding of the third inference packet 312 to the queue 302, and may still operate within the context established by the second management packet 316. After completing execution of the third inference packet 312, the second management packet 316 (representing the batched execution) may be transmitted back to the first processor. This scenario, depicted conceptually in FIG. 3B, may allow the system to maintain high throughput for short-duration inferences by processing multiple queue entries per kernel-managed management packet, reducing total latency and per-inference packet latency.

Executing multiple inference packets for the same management packet may be selected based on one or more conditions. In certain implementations, the system may determine that a duration of the execution of a preceding inference packet (such as the first inference packet, the second inference packet 310, or combinations thereof) on the second processor is less than a latency associated with adding the next management packet (such as a potential third management packet 318) and having the next management packet arrive at the second processor. In certain implementations, the measured execution time may be compared to a pre-configured or dynamically estimated threshold representing the typical management packet latency (such as 50 microseconds, 100 microseconds, 150 microseconds, 200 microseconds). If the execution time is below the threshold, this condition for batching may be met. In additional or alternative implementations, the system may determine that the next expected management packet (such as a third management packet 318 corresponding to the third inference packet 312, which may have been submitted by the first management thread 304) is not currently available at a management thread. In further implementations, the system may determine that executing an inference packet with batched processing does not exceed a configured batch limit. The batch limit may impose an upper bound on the number of inference packets that are allowed to be processed consecutively under the context of a single management packet (such as a limit of 2, 3, 5, or 10 inference packets). The batch limit may be imposed to prevent excessive batching from adversely affecting kernel-level accounting, as processing an unbounded number of inference packets under a single management packet context may cause the operating system scheduler to lose accurate visibility into individual workload completions, potentially resulting in incorrect resource utilization reporting, missed scheduling deadlines, or degraded quality of service enforcement. If the limit is not exceeded (and any other required conditions are met), the third inference packet 312 may be executed within the same context for the same management packet.

In certain implementations, the first management thread 304 and the second management thread 306 may be created and managed by a library framework executing on the first processor. This library framework, which may be referred to as the queue library, may be configured to the instantiation of the required number of management threads (such as the first management thread 304 and the second management thread 306) upon the creation of the user-mode queue 302. The framework may also manages the lifecycle of the management threads, orchestrate the management threads' interaction with the operating system's kernel mode packet scheduler for submitting management packets (such as the first management packet 314 and the second management packet 316), synchronize the management threads' activities based on the described triggers (such as inference packet additions to queue 302 and management packet completions signaled from the second processor), provide the logic for proactive packet submission and latency hiding, or a combination thereof.

Furthermore, the library framework may manage the first management thread 304 and the second management thread 306 independently of direct control by an application associated with the adding of the first inference packet 308 (or subsequent inference packets such as 310, 312, or a combination thereof). The application running on the first processor may interact with the system primarily through the high-level APIs provided by the library framework. For example, the application may call functions to create or destroy the queue 302, to add inference packets (such as 308, 310, 312, or a combination thereof) to the queue 302, to retrieve results from the queue 302, or a combination thereof.

In certain implementations, the system may employ a read timeout mechanism to handle scenarios in which the application ceases to add inference packets to the queue 302. When no new inference packet is detected within a configurable timeout duration, a management packet that has been proactively submitted and is awaiting a corresponding inference packet on the second processor may be caused to return to the first processor without processing an inference packet. Upon expiration of the read timeout, no further management packets may be submitted by the management threads (such as the first management thread 304 and the second management thread 306) until the application resumes adding inference packets to the queue 302. When the application subsequently resumes writing inference packets, the management packet submission process may reinitialize, such as by submitting an initial pair of management packets via the first management thread 304 and the second management thread 306, respectively, in a manner similar to the initial startup sequence. In certain implementations, accounting for management packets, including tracking outstanding management packets and coordinating the read timeout behavior, may be managed using fence-based synchronization mechanisms associated with the management threads.

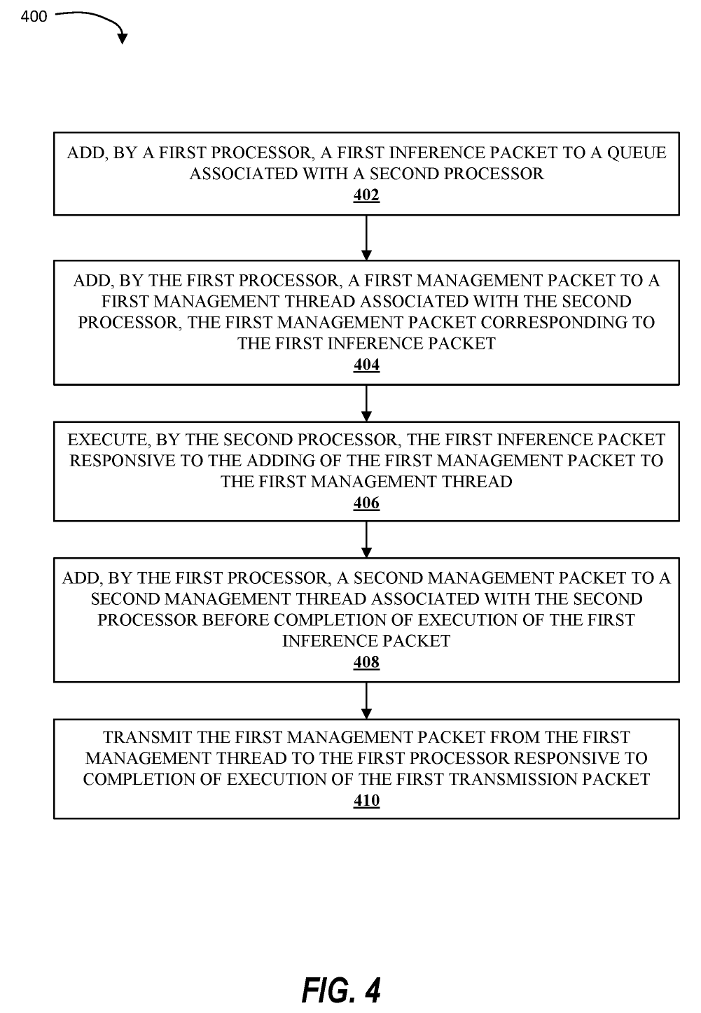

FIG. 4 depicts a method 400 for inference packet processing according to one aspect of the present disclosure. The method 400 may be implemented on a computer system, such as the system 300A, B. For example, the method 400 may be implemented by the first processor, the second processor, or a combination thereof. The method 400 may also be implemented by a set of instructions stored on a computer readable medium that, when executed by a processor, cause the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

At block 402, the method 400 may include adding, by a first processor, a first inference packet to a queue associated with a second processor. For example, a first processor may add a first inference packet 308 to a queue 302 associated with a second processor. In certain implementations, the queue 302 may include a user-mode shared memory region accessible by the first processor and the second processor. For instance, the first processor may be a Central Processing Unit (CPU) and the second processor may be a specialized accelerator processor including at least one of a Neural Processing Unit (NPU) or a Digital Signal Processor (DSP).

At block 404, the method 400 may include adding, by the first processor, a first management packet to a first management thread associated with the second processor, where the first management packet corresponds to the first inference packet. For example, the first processor may add a first management packet 314 to a first management thread 304 associated with the second processor, where the first management packet 314 corresponds to the first inference packet 308. In certain implementations, adding the first management packet 314 to the first management thread 304 may involve submitting the first management packet 314 via an operating system scheduler associated with the first processor.

At block 406, the method 400 may include executing, by the second processor, the first inference packet responsive to the adding of the first management packet to the first management thread. For example, the second processor may execute the first inference packet 308 responsive to the adding of the first management packet 314 to the first management thread 304.

At block 408, the method 400 may include adding, by the first processor, a second management packet to a second management thread associated with the second processor before completion of execution of the first inference packet. For example, the first processor may add a second management packet 316 to a second management thread 306 associated with the second processor before completion of execution of the first inference packet 308 by the second processor. In certain implementations, the second management packet 316 may be added prior to the first processor writing a subsequent inference packet, such as a second inference packet 310, to the queue 302.

At block 410, the method 400 may include transmitting the first management packet from the first management thread to the first processor responsive to completion of execution of the first inference packet. For example, the first management packet 314 may be transmitted from the first management thread 304 to the first processor responsive to completion of execution of the first inference packet 308 by the second processor.

In certain implementations, following the processing of the first inference packet 308, subsequent inference packets may be processed individually. For example, the method 400 may further include adding, by the first processor, a second inference packet to the queue, where the second management packet corresponds to the second inference packet. For example, the first processor may add a second inference packet 310 to the queue 302, where the second management packet 316 corresponds to the second inference packet 310. In certain implementations, the second inference packet 310 may be added to the queue 302 responsive to the first processor receiving an output corresponding to the first inference packet 308

In certain implementations, the method 400 may further include executing, by the second processor, the second inference packet responsive to the adding of the second inference packet to the queue. For example, the second processor may execute the second inference packet 310 responsive to the adding of the second inference packet 310 to the queue 302.

In certain implementations, the method 400 may further include transmitting the second management packet from the second management thread to the first processor. For example, the second management packet 316 may be transmitted from the second management thread 306 to the first processor, typically responsive to the completion of the execution of the second inference packet 310.

In certain implementations, the method 400 may continue processing subsequent packets in a similar manner. The method 400 may further include adding, by the first processor, a third management packet to the first management thread before completion of execution of the second inference packet. For example, the first processor may add a third management packet 318 to the first management thread 304 before the second processor completes execution of the second inference packet 310. In certain implementations, the third management packet 318 may be added to the first management thread 304 responsive to completion of the adding, by the first processor, of the second inference packet 310 to the queue 302.

In certain implementations, the method 400 may further include adding, by the first processor, a third inference packet to the queue, where the third management packet corresponds to the third inference packet. For example, the first processor may add a third inference packet 312 to the queue 302, where the third management packet 318 corresponds to the third inference packet 312.

In certain implementations, the method 400 may further include executing, by the second processor, the third inference packet responsive to the adding of the third inference packet to the queue. For example, the second processor may execute the third inference packet 312 responsive to the adding of the third inference packet 312 to the queue 302. This individual processing workflow may be suitable when the execution time of inference packets is sufficiently long. For instance, the method may involve determining that a duration of the execution of the second inference packet 310 on the second processor is greater than or equal to a latency associated with adding the third management packet 318 to the queue 302. The latency may represent, for example, the Inter-Processor Communication (IPC) time required for the management packet to travel from the first processor to the second processor via the operating system scheduler.

In certain implementations, particularly when inference packet execution times are short, multiple inference packets may be batched under a single management packet. This may occur, for example, after block 410. The method may involve determining that a duration of the execution of a preceding inference packet (e.g., the second inference packet 310) on the second processor is less than a latency associated with adding a subsequent management packet (e.g., a third management packet 318) to the appropriate management thread (e.g., the first management thread 304). If this condition is met, the method may proceed with batching.

In certain implementations, the method 400 may include adding, by the first processor, a second inference packet 310 to the queue 302, where the second management packet 316 corresponds to the second inference packet 310, and executing, by the second processor, the second inference packet 310 responsive to the adding of the second inference packet 310 to the queue 302. Subsequently, the method may include adding, by the first processor, a third inference packet 312 to the queue 302. In this batched case, the second management packet 316 may also correspond to the third inference packet 312. The method may then include executing, by the second processor, the third inference packet 312 responsive to the adding of the third inference packet 312 to the queue 302, where the execution occurs under the context of the second management packet 316. Before executing the third inference packet 312 under the second management packet 316, the method may further include determining that processing the third inference packet 312 does not exceed a configurable batch limit (e.g., a maximum number of inference packets allowed per management packet). Finally, the method may include transmitting the second management packet 316 (which handled both the second inference packet 310 and the third inference packet 312) responsive to completion of the execution of the last packet in the batch (in this example, the third inference packet 312).

In one or more aspects, techniques for improving device operation may include additional aspects, such as any single aspect or any combination of aspects described below or in connection with one or more other processes or devices described elsewhere herein. In a first aspect, a method includes adding, by a first processor, a first inference packet to a queue associated with a second processor; adding, by the first processor, a first management packet to a first management thread associated with the second processor, the first management packet corresponding to the first inference packet; executing, by the second processor, the first inference packet responsive to the adding of the first management packet to the first management thread; adding, by the first processor, a second management packet to a second management thread associated with the second processor before completion of execution of the first inference packet; and transmitting the first management packet from the first management thread to the first processor responsive to completion of execution of the first inference packet.

In a second aspect according to the first aspect, the method further includes adding, by the first processor, a second inference packet to the queue, wherein the second management packet corresponds to the second inference packet; executing, by the second processor, the second inference packet responsive to the adding of the second inference packet to the queue; and transmitting the second management packet from the second management thread to the first processor.

In a third aspect according to the second aspect, the second inference packet is added to the queue responsive to receiving, at the first processor, an output corresponding to the first inference packet.

In a fourth aspect according to any one of the second or third aspects, the second management packet is added prior to adding, by the first processor, the second inference packet to the queue.

In a fifth aspect according to any one of the second through fourth aspects, the method further includes adding, by the first processor, a third management packet to the first management thread before completion of execution of the second inference packet; adding, by the first processor, a third inference packet to the queue, wherein the third management packet corresponds to the third inference packet; and executing, by the second processor, the third inference packet responsive to the adding of the third inference packet to the queue.

In a sixth aspect according to the fifth aspect, the third management packet is added to the first management thread responsive to completion of the adding, by the first processor, of the second inference packet to the queue.

In a seventh aspect according to the fifth aspect, the method further includes determining that a duration of the execution of the second inference packet on the second processor is greater than or equal to a latency associated with adding the third inference packet to the queue.

In an eighth aspect according to any of the first through seventh aspects, the method further includes adding, by the first processor, a second inference packet to the queue, wherein the second management packet corresponds to the second inference packet; executing, by the second processor, the second inference packet responsive to the adding of the second inference packet to the queue; adding, by the first processor, a third inference packet to the queue, wherein the second management packet corresponds to the third inference packet; executing, by the second processor, the third inference packet responsive to the adding of the third inference packet to the queue; and transmitting the second management packet responsive to completion of the third inference packet.

In a ninth aspect according to the eighth aspect, the method further includes determining that a duration of the execution of the second inference packet on the second processor is less than a latency associated with adding a third management packet to the first management thread.

In a tenth aspect according to the eighth aspect, the method further includes determining that the third inference packet does not exceed a batch limit.

In an eleventh aspect according to the first aspect, the queue includes a user-mode shared memory region accessible by the first processor and the second processor.

In a twelfth aspect according to the first aspect, adding the first management packet to the first management thread includes submitting the first management packet via an operating system scheduler associated with the first processor.

In a thirteenth aspect according to any of the first through twelfth aspects, the first processor is a Central Processing Unit (CPU) and the second processor is a specialized accelerator processor including a Neural Processing Unit (NPU), a Digital Signal Processor (DSP), or a combination thereof.

In a fourteenth aspect, a system includes a first processor and a second processor, wherein the first processor is configured to add a first inference packet to a queue associated with the second processor and add a first management packet to a first management thread associated with the second processor, the first management packet corresponding to the first inference packet; wherein the second processor is configured to execute the first inference packet responsive to the adding of the first management packet to the first management thread; wherein the first processor is further configured to add a second management packet to a second management thread associated with the second processor before completion of execution of the first inference packet; and wherein the second processor is further configured to transmit the first management packet from the first management thread to the first processor responsive to completion of execution of the first inference packet.

Additionally, the system may perform or operate according to one or more aspects as described below. In some implementations, the system includes a wireless device, such as a UE. In some implementations, the system includes a remote server, such as a cloud-based computing solution, which receives image data for processing to determine output image frames. In some implementations, the system may include at least one processor, and a memory coupled to the processor. The processor may be configured to perform operations described herein with respect to the system. In some other implementations, the system may include a non-transitory computer-readable medium having program code recorded thereon and the program code may be executable by a computer for causing the computer to perform operations described herein with reference to the apparatus. In some implementations, the system may include one or more means configured to perform operations described herein.

In a fifteenth aspect according to the fourteenth aspect, the first processor is further configured to add a second inference packet to the queue, wherein the second management packet corresponds to the second inference packet; and wherein the second processor is further configured to execute the second inference packet responsive to the adding of the second inference packet to the queue and transmit the second management packet from the second management thread to the first processor.

In a sixteenth aspect according to the fifteenth aspect, the second inference packet is added to the queue responsive to receiving, at the first processor, an output corresponding to the first inference packet.

In a seventeenth aspect according to the fifteenth or sixteenth aspects, the second management packet is added prior to writing, by the first processor, the second inference packet to the queue.

In an eighteenth aspect according to the any one of the fifteenth through seventeenth aspect, the first processor is further configured to add a third management packet to the first management thread before completion of execution of the second inference packet and add a third inference packet to the queue, wherein the third management packet corresponds to the third inference packet; and wherein the second processor is further configured to execute the third inference packet responsive to the adding of the third inference packet to the queue.

In a nineteenth aspect according to the fourteenth aspect, the first processor is further configured to add a second inference packet to the queue, wherein the second management packet corresponds to the second inference packet; wherein the second processor is further configured to execute the second inference packet responsive to the adding of the second inference packet to the queue; wherein the first processor is further configured to add a third inference packet to the queue, wherein the second management packet corresponds to the third inference packet; and wherein the second processor is further configured to execute the third inference packet responsive to the adding of the third inference packet to the queue and transmit the second management packet responsive to completion of the third inference packet.

In a twentieth aspect, a System-on-a-Chip (SoC) includes a first processor and a second processor, wherein the first processor is configured to add a first inference packet to a queue associated with the second processor and add a first management packet to a first management thread associated with the second processor, the first management packet corresponding to the first inference packet; wherein the second processor is configured to execute the first inference packet responsive to the adding of the first management packet to the first management thread; wherein the first processor is further configured to add a second management packet to a second management thread associated with the second processor before completion of execution of the first inference packet; and wherein the second processor is further configured to transmit the first management packet from the first management thread to the first processor responsive to completion of execution of the first inference packet.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system’s registers and memories into other data similarly represented as physical quantities within the computer system’s registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIGS. 1 or 2. As another example, one or more blocks associated with FIG. 4 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
adding, by a first processor, a first inference packet to a queue associated with a second processor;
adding, by the first processor, a first management packet to a first management thread associated with the second processor, the first management packet corresponding to the first inference packet;
executing, by the second processor, the first inference packet responsive to the adding of the first management packet to the first management thread;
adding, by the first processor, a second management packet to a second management thread associated with the second processor before completion of execution of the first inference packet; and
transmitting the first management packet from the first management thread to the first processor responsive to completion of execution of the first inference packet.

2. The method of claim 1, further comprising:
adding, by the first processor, a second inference packet to the queue, wherein the second management packet corresponds to the second inference packet;
executing, by the second processor, the second inference packet responsive to the adding of the second inference packet to the queue; and
transmitting the second management packet from the second management thread to the first processor.

3. The method of claim 2, wherein the second inference packet is added to the queue responsive to receiving, at the first processor, an output corresponding to the first inference packet.

4. The method of claim 2, wherein the second management packet is added prior to adding, by the first processor, the second inference packet to the queue.

5. The method of claim 2, further comprising:
adding, by the first processor, a third management packet to the first management thread before completion of execution of the second inference packet;
adding, by the first processor, a third inference packet to the queue, wherein the third management packet corresponds to the third inference packet; and
executing, by the second processor, the third inference packet responsive to the adding of the third inference packet to the queue.

6. The method of claim 5, wherein the third management packet is added to the first management thread responsive to completion of the adding, by the first processor, of the second inference packet to the queue.

7. The method of claim 5, further comprising determining that wherein a duration of the execution of the second inference packet on the second processor is greater than or equal to a latency associated with adding the third inference packet to the queue.

8. The method of claim 1, further comprising:
adding, by the first processor, a second inference packet to the queue, wherein the second management packet corresponds to the second inference packet;
executing, by the second processor, the second inference packet responsive to the adding of the second inference packet to the queue;
adding, by the first processor, a third inference packet to the queue, wherein the second management packet corresponds to the third inference packet;
executing, by the second processor, the third inference packet responsive to the adding of the third inference packet to the queue; and
transmitting the second management packet responsive to completion of the third inference packet.

9. The method of claim 8, further comprising determining that a duration of the execution of the second inference packet on the second processor is less than a latency associated with adding a third management packet to the first management thread.

10. The method of claim 8, further comprising determining that the third inference packet does not exceed a batch limit.

11. The method of claim 1, wherein the queue comprises a user-mode shared memory region accessible by the first processor and the second processor.

12. The method of claim 1, wherein adding the first management packet to the first management thread comprises submitting the first management packet via an operating system scheduler associated with the first processor.

13. The method of claim 1, wherein the first processor is a Central Processing Unit (CPU) and the second processor is a specialized accelerator processor comprising at least one of a Neural Processing Unit (NPU) or a Digital Signal Processor (DSP).

14. A system comprising:
a first processor; and
a second processor,
wherein the first processor is configured to:
add a first inference packet to a queue associated with the second processor; and
add a first management packet to a first management thread associated with the second processor, the first management packet corresponding to the first inference packet,
wherein the second processor is configured to:
execute the first inference packet responsive to the adding of the first management packet to the first management thread,
wherein the first processor is further configured to:
add a second management packet to a second management thread associated with the second processor before completion of execution of the first inference packet, and
wherein the second processor is further configured to:
transmit the first management packet from the first management thread to the first processor responsive to completion of execution of the first inference packet.

15. The system of claim 14, wherein the first processor is further configured to:
add a second inference packet to the queue, wherein the second management packet corresponds to the second inference packet, and
wherein the second processor is further configured to:
execute the second inference packet responsive to the adding of the second inference packet to the queue; and
transmit the second management packet from the second management thread to the first processor.

16. The system of claim 15, wherein the second inference packet is added to the queue responsive to receiving, at the first processor, an output corresponding to the first inference packet.

17. The system of claim 15, wherein the second management packet is added prior to writing, by the first processor, the second inference packet to the queue.

18. The system of claim 15, wherein the first processor is further configured to
add a third management packet to the first management thread before completion of execution of the second inference packet; and
add a third inference packet to the queue, wherein the third management packet corresponds to the third inference packet, and
wherein the second processor is further configured to:
execute the third inference packet responsive to the adding of the third inference packet to the queue.

19. The system of claim 14, wherein the first processor is further configured to:
add a second inference packet to the queue, wherein the second management packet corresponds to the second inference packet,
wherein the second processor is further configured to:
execute the second inference packet responsive to the adding of the second inference packet to the queue,
wherein the first processor is further configured to:
add a third inference packet to the queue, wherein the second management packet corresponds to the third inference packet, and
wherein the second processor is further configured to:
execute the third inference packet responsive to the adding of the third inference packet to the queue; and
transmit the second management packet responsive to completion of the third inference packet.

20. A System-on-a-Chip (SoC) comprising:
a first processor; and
a second processor,
wherein the first processor is configured to:
add a first inference packet to a queue associated with the second processor; and
add a first management packet to a first management thread associated with the second processor, the first management packet corresponding to the first inference packet,
wherein the second processor is configured to:
execute the first inference packet responsive to the adding of the first management packet to the first management thread,
wherein the first processor is further configured to:
add a second management packet to a second management thread associated with the second processor before completion of execution of the first inference packet, and
wherein the second processor is further configured to:
transmit the first management packet from the first management thread to the first processor responsive to completion of execution of the first inference packet.
